(19) United States
(12) Patent Application Publication
(10) Pub. No.: US 2012/0040470 A1
(43) Pub. Date: Feb. 16, 2012

(54) SINGLE-USE MICROFLUIDIC TEST CARTRIDGE FOR THE BIOASSAY OF ANALYTES

(75) Inventors: Ingmar Dorn, Koln (DE); Andreas Schade, Essen (DE)

(73) Assignee: BAYER TECHNOLOGY SERVICES GMBH, Leverkusen (DE)

(21) Appl. No.: 13/263,356

(22) PCT Filed: Mar. 27, 2010
(86) PCT No.: PCT/EP2010/001949

§ 371 Date: Oct. 7, 2011

(30) Foreign Application Priority Data
Apr. 9, 2009 (DE) 10 2009 016 712.9

(51) Int. Cl. G01N 21/75

(52) U.S. Cl. 436/169; 422/402

(57) ABSTRACT

A disposable test cassette for qualitative and/or quantitative analysis of analytes, having a structured body having introduced cavities connected to one another by channels, at least one inlet for introducing a sample fluid containing the analyte, at least one reagent chamber in which one or more reagents are stored and at least one detection chamber in which a signal for detection or quantitative analysis of the analyte is detected, wherein a floor or ceiling of the detection chamber is a signal transducer or a window for detection of a signal, fluid cannot be drawn by capillary forces into the reagent chamber or to the opening, and at least the reagents in the reagent chamber are stored in dry form. Also disclosed is an apparatus for bioassaying analytes including the test cassette, and also a method for operating this apparatus.

This application is a 371 of PCT/EP2010/001949, filed Mar. 27, 2010, which claims foreign priority benefits of DE 10 2009 016 712.9 filed Apr. 9, 2009, the disclosures of which are incorporated herein by reference.

The present invention relates to a microfluidic technology-based disposable test cassette for bioassaying analytes by means of biosensors and/or chemosensors, to an apparatus for bioassaying analytes by means of biosensors and/or chemosensors comprising the test cassette according to the invention, to a method for operating said test cassette, and to its use in environmental analysis, the food sector, human and veterinary diagnostics and crop protection.

Biosensors or chemosensors are devices which can qualitatively or quantitatively detect an analyte using a signal transducer and a recognition reaction. In general, a recognition reaction is the specific binding or reaction of an analyte to/with a recognition element.

Examples of recognition reactions are the binding of ligands to complexes, the complexation of ions, the binding of ligands to (biological) receptors, membrane receptors or ion channels, of antigens or haptens to antibodies, of substrates to enzymes, of DNA or RNA to particular proteins, the hybridization of DNA/RNA/PNA or the processing of substrates by enzymes.

Analytes can be: ions, proteins, natural or synthetic antigens or haptens, hormones, cytokines, monosaccharides and oligosaccharides, metabolic products or other biochemical markers which are used in diagnostics, enzyme substrates, DNA, RNA, PNA, potential active compounds, drugs, cells, viruses.

Examples of recognition elements are: natural or synthetic receptors such as, for example, complexing agents for metals/metal ions, cyclodextrins, crown ethers, antibodies, antibody fragments, anticalins, enzymes, DNA, RNA, PNA, DNA/RNA-binding proteins, membrane receptors, ion channels, cell-adhesion proteins or else gangliosides, enzymes, monosaccharides or oligosaccharides and haptamers.

These biosensors or chemosensors can be used in environmental analysis, the food sector, human and veterinary diagnostics and crop protection in order to determine analytes qualitatively and/or quantitatively. The specificity of the recognition reaction also enables qualitative or quantitative determination of analytes in complex samples such as, for example, ambient air, polluted water or body fluids without or with only minor previous purification. In addition, biosensors or chemosensors can also be used in (bio)chemical research and screening of active compounds in order to study the interaction between two different substances (e.g. between proteins, DNA, RNA, or biologically active substances and proteins, DNA, RNA, etc.).

A new class of electrical biosensors is based on the detection of analytes which are labelled by means of metal particles, for example nanoparticles. For detection, these particles are enlarged by autometallographic deposition to the extent that they short-circuit a microstructured circuit. This is demonstrated by a simple direct-current resistance measurement (U.S. Pat. No. 4,794,089; U.S. Pat. No. 5,137,827; U.S. Pat. No. 5,284,748). The detection of nucleic acids by direct-current resistance measurement has been recently demonstrated (R. Möller, A. Csáki, J. M. Köhler, and W. Fritzsche, Langmuir 17, 5426 (2001)).

Field-effect transistors can be used as electronic transducers, for example for an enzymatic reaction (Zayats et al. Biosens. & Bioelectron. 15, 671 (2000)).

Mechanical transducers described are oscillating crystals in which the change in resonance frequency is achieved by mass addition (Steinem et al. Biosens. & Bioelectronics 12, 787 (1997)). In an alternative mechanical transducer, surface waves which are modified by target adsorption are activated using interdigital structures (Howe et al., Biosens. & Bioelectron. 15, 641 (2000)).

If the target molecules are labelled with magnetic beads, the recognition reaction can be detected via the magnetic influence of the beads on the Giant Magnetic Resistance (GMR) of a corresponding resistor (Baselt et al. Biosens. and Bioelectron. 13, 731 (1998)).

The integration of the recognition reaction with the signal transducer to give a biosensor or chemosensor can be achieved by immobilizing the recognition element or the analyte on the surface of the signal transducer. As a result of the recognition reaction, i.e. the binding or the reaction of the analyte to/with the recognition element, the optical properties of the medium directly on the surface of the signal transducer change (e.g. change in optical refractive index, in absorption, in fluorescence, in phosphorescence, in luminescence, etc.), and this is translated by the signal transducer into a measurement signal.

Optical (planar) waveguides are a class of signal transducers with which it is possible to detect the change in optical properties of a medium which adjoins a wave-guiding layer, typically a dielectric. If light is transported as a guided mode in the wave-guiding layer, the light field does not decline abruptly at the medium/waveguide interface, but decays exponentially in the detection medium adjoining the waveguide. This exponentially decaying light field is referred to as an evanescent field. If use is made of very thin waveguides whose refractive index is extremely different from that of the adjoining medium, decay lengths of the evanescent field (intensity drops to the value of 1/e) of <200 nm are achieved. If the optical properties of the medium adjoining the waveguide change within the evanescent field—for example by a change in optical refractive index (U.S. Pat. No. 4,815,843; U.S. Pat. No. 5,442,169) or in luminescence (U.S. Pat. No. 5,959,292; EP 0 759 159; WO 96/35940)—this can be detected by means of a suitable measurement layout. It is crucial for the use of waveguides as signal transducers in biosensors or chemosensors that the change in the optical properties of the medium is detected only very close to the surface of the waveguide. Specifically, if the recognition element or the analyte is immobilized at the interface of the waveguide, binding to the recognition element or reaction of the recognition element can be detected in a surface-sensitive manner when the optical properties of the detection medium (liquid, solid, gaseous) change at the interface to the waveguide.

To simplify operation of chemosensors and biosensors, attempts have already been made for some years to reduce the size of these devices and to have, if possible, all the reagents required for qualitative and/or quantitative determination of a sample provided ready to use in a test cassette. More particularly, use is made of microfluidic technology and the aim is to provide cost-effective, storable and simple-to-operate disposable cassettes which can deliver real-time reproducible results.

The known challenges concerning a microfluidic system are that:
mixing of the analyte with the detection reagent for detection is suboptimal because it is not possible to precisely control laminar flows,
laminar flow is affected by varying surface properties which are difficult to control during production and storage of a test cassette, for example surface charge, contaminants, hydrophobicity, wetting, etc.
air bubbles can form during transport of the fluid,
it is not possible to precisely control flows and, more particularly, the volume and rate thereof,
precise temporal control of the individual reaction steps in lateral flow is not possible.

For example, DE102005011530 describes a microfluidic apparatus for real-time quantitative determination of a very small amount of analytes. Real-time analysis is achieved by the sample flowing into a detection unit. The detection unit consists of a flow channel in which analyte capture units for capturing the analyte, for example antibodies, are immobilized on a multiplicity of analyte detection units along the flow channel. The analyte is quantitatively determined by means of, for example, an optical signal. The analyte sample is transported into the flow channel using, for example, a micropump. The aim of the above-mentioned apparatus is to optimize the number of analytes which are captured in the direction of the flow by the analyte capture unit. The analytes are quantitatively determined over a broad area (the length of the flow channel) without reducing detection sensitivity. This apparatus consists of a multiplicity of microscopic constituents based on semiconductor technologies or microscopic precision apparatuses—micropumps, microvalves, sensors and the like which are miniaturized, accumulated and integrated. However, producing and operating this apparatus is too complicated and too expensive for possible use as a disposable test assay.

WO2005/070533 describes a microfluidic apparatus for determining the concentration of an analyte in a sample fluid, comprising a structured body which has chamber systems connected to channel systems, optionally with integrated filter units having an inlet and an outlet, and which is sealed on at least one side by a sealing layer. This apparatus has a reaction chamber which contains reagents for binding to at least one component of the sample fluid, which are immobilized either on the cover of the chamber or on coated particles. A sample chamber is filled with the sample fluid through the inlet, and the inlet is closed by means of a cover. The sample fluid is transported from the sample chamber into the reaction chamber through a channel system by means of a pump. The apparatus has further channel systems which contain a label fluid and a wash fluid, and a discharge channel system for evacuating waste fluids. Various parts of the complex channel systems can be sealed by means of soft seals which can, as required, be broken by slight pressure. The flow direction in the apparatus is ensured by means of valves and brush-like or valve-like fluid diodes. After the reaction chamber has reacted with the binding reagent, the label fluid is added to the reaction chamber and the non-immobilized parts of the sample fluids are washed off by means of a wash fluid. The reaction is detected by measuring an optical or magnetic signal in the reaction chamber. Optical signals are measured through the cover of the reaction chamber. The above-mentioned sealing layer forms the cover of the reaction chamber and is suitably transparent. The apparatus enables precise control of volumes and reaction times. However, the design of this apparatus requires several actions in the reaction chamber before measurement can commence and is accordingly elaborate. Owing to the fluidic elements used, the apparatus becomes very complex, and this is reflected in a tendency to malfunction and in high production costs. The use of fluidic elements also reduces the storability of the apparatus.

With regard to the storability and transportability of cassettes, use is made in particular in the prior art of dry assay technology, in which all reagents are available in a dry state in the cassette, in separate chambers if necessary. The sample fluid is usually transferred from one chamber to the next by means of microfluidic channels.

WO 2005/088300 describes an integrated microfluidic test cassette for blood analysis, consisting of a lower body part and an upper body part. Both elements are structured with chambers and channels which are closed by joining the two parts. The test cassette has one or more pretreatment elements (pretreatment chamber or channels) for preparing a sample, one or more multilayer dry assay elements (detection chamber) for recognizing one or more analytes of the sample, and one or more channels (average <=3 mm) which connect the pretreatment elements to the multilayer dry assay elements. The pretreatment elements are, in particular, filter elements or elements having porous properties in the form of a channel or of a (micro/nano)cushion which, if necessary, bear dry reagents. The sample is first conducted through the pretreatment elements, then into the multilayer dry assay element. The multilayer dry assay recognition element has at least one functional layer which bears, in a dry and stable form, recognition elements for a qualitative and quantitative assay. This reagent layer consists of a water-absorbing layer in which excitable recognition elements are distributed fairly regularly in a hydrophilic polymeric binding material (gelatin, agarose, etc.). Detection is achieved by reflection photometry through a light-transparent window, by illuminating a detection layer in the multilayer dry assay element, in which layer the optically excitable fluid from the recognition reaction is diffused. To transport the sample, use is made of, for example, capillary forces or pressure. The disadvantage of this apparatus is that the design of the multilayer dry assay element is elaborate. Precise control of volumes, of mixing and of incubation times is not possible, and so the test results are quantitatively irreproducible.

Both in WO 2005/088300 and in WO2005/070533, the cassette is inserted into an apparatus for operating the cassette, which has a light source for illuminating the reaction chamber, a filter for concentrating the signal from the reaction chamber, and a detection unit.

Lateral flow assays (LFA) have already been known for many years for biochemical analysis. Lateral flow assays (LFA) utilize the effect of the antibody-antigen reaction. In addition, the sample (solution) to be analysed is drawn over the sensor surface by capillary forces. To detect analytes by means of LFAs, it is possible to perform, for example, a direct, competitive immunoassay on a nitrocellulose strip, with the sample to be analysed being drawn through the entire nitrocellulose strip as a result of capillary forces. The zone in which the anti-analyte antibody has been immobilized serves as a detection zone for the strip test. An example of an LFA assay for detecting mycotoxins (e.g. deoxynivalenol) is the Reveal Assay (test cassette) from Neogen, Lansing, Mich., USA, with the accompanying AccuScan reader. The test cassette is inserted into the reader and the device takes a picture of the results area of the strip test. The reader interprets the results picture and if a line is recognized, a score is given. The device eliminates the subjectivity of interpretation and provides objective, traceable documentation of the test result. The described test is simple and can be carried out relatively quickly, and dispenses with elaborate readers. The disadvantage is that the method permits only qualitative mycotoxin detection.

From the prior art, there was a need for a cost-effective, storable and simple-to-operate device for carrying out biochemical test methods for bioanalysis, environmental analysis, agrodiagnostics, the food sector, human and veterinary diagnostics and crop protection in order to determine analytes qualitatively and/or quantitatively. It is a further object of the present invention to enable reproducible quantitative real-time determination by means of a simple apparatus, with simple handling. For this purpose, the present invention should enable control of the reaction conditions, more particularly volumes and times, but also, in the best case, optimal mixing and control of operating temperature.

This object is achieved according to the invention by a microfluidic test cassette for qualitative and/or quantitative analysis of analytes which includes all the reagents, in dry form, required for carrying out the test method. The test cassette according to the invention has a structured body into which cavities which are connected to one another by channels have been introduced. According to the invention, the test cassette has at least one inlet for introducing an analyte-containing sample fluid, at least one reagent chamber in which one or more reagents for reaction with the analyte or for mixing with the sample fluid are stored, and at least one detection chamber in which a signal for detection or quantitative analysis of the analyte is detected, and is characterized in that:
the floor or the ceiling of the detection chamber is a signal transducer or a window for detection of a signal,
the channels are configured such that the sample fluid is not drawn by capillary forces into the chamber or to the opening,
the reagents in the reagent chamber and, optionally, further reagents in the detection chamber are stored in dry form.

Within the context of the invention, a precisely defined volume of sample fluid is transported in the channels and in the chambers, and this is enabled by the configuration of the channels and the use of a suitable device for transporting the sample fluid. Reaction times can likewise be precisely controlled, and this contributes to better reproducibility of the analysis. Appropriate design of the chambers and of the channels ensures an optimal flow profile with reduced void volume and optimal contact with the immobilized detection reagents possibly present. In the chambers, various reaction steps are carried out, such as, for example, reconstitution of the reagents, mixing of the reagents with the sample fluid, reaction between reagents and analytes. In the present invention, the detection step is carried out directly after a recognition reaction without a prior washing operation, and this further simplifies the design of the cassette and handling thereof.

### BRIEF DESCRIPTION OF THE DRAWINGS

The invention will now be described in greater detail with reference to the drawings, wherein the drawings depict the features as indicated below:

FIG. 1: Test cassette

FIG. 2: Test cassette, side view

FIG. 3: Test cassette with dimensioning

FIG. 4: Design of the test cassette—lateral view from above

FIG. 5: Design of the test cassette—lateral view from below

FIG. 6: PWG biochip

FIG. 7: PWG biochip, side view

FIG. 8: Dimensions of the PWG biochip

FIG. 9: Diagram of the apparatus according to the invention for operating the test cassette

FIG. 10: Effect of temperature on the dose-response curve of an assay

FIG. 11: Experimental setup for measuring temperature control by means of Peltier elements

FIG. 12: Simulation of the cooling rate of the test cassette

FIG. 13: Dew point temperature diagram

FIG. 14: Effect of incubation time on the dose-response curve of the assay based on the mycotoxin fumonisin

The body can be transparent or lightproof and consist of various polymeric materials, such as, for example, polyoxymethylene (POM), poly(methyl methacrylate) (PMMA), polystyrene (PS), polypropylene (PP), polyamide, polycyclic olefins, polycarbonates, polyethylene (PE), polyethylene terephthalate (PET), polydimethylsiloxanes (PDMS), natural rubber or derivates thereof, polyurethanes, Teflon or analogues or various inorganic materials, such as, for example, glass, quartz, silicon. Preferably, POM and polyamide are used. The bodies are produced using known methods, such as, for example, machine processing (milling, etc.), injection moulding, embossing techniques or, in the case of glass/inorganic materials, by photolithography/etching or other known methods.

The test cassette can be of any shape and size, as long as the test cassette still has a low total volume and is simple to handle.

Preferably, the chambers and the channels are incorporated into the body and sealed on at least one side by means of a sealing unit with the exception of the inlet and, usually, of optional air holes and/or of a sample chamber.

It is advantageous to control the temperature in the reagent chamber and in the detection chamber during operation of the test cassette.

For this purpose, preferably the test cassette is constructed such that it can be temperature-controlled by contact with temperature-controllable elements.

Preferably, the design of the test cassette is such that the optional sample chamber, the reagent chamber and the detection chamber face the lower side of the body. The signal transducer or the window for detection then preferably form the floor of the detection chamber. Preferably, this side of the cassette is sealed with a thin sealing unit, more particularly a sealing film. The sealing unit can be lightproof or transparent. When the cassette is placed onto a temperature-controllable surface, rapid temperature equalization between the temperature-controlled base and the sample solution in the chambers can thus take place.

In a preferred embodiment of the test cassette according to the invention, the sealing unit is a sealing film having a thickness in the range from 30 μm to 1000 μm, preferably in the range from 50 μm to 500 μm. It is advantageous when the sealing film can be fastened tautly over the body and cannot bent. For example, polyolefin films or films made of poly(methyl methacrylate) (PMMA) can be used as sealing films.

In a particular embodiment of the invention, the sealing unit is applied to the upper and lower sides of the test cassette. This simplifies production of the test cassette according to the invention. The upper and lower sealing films can be of the same thickness or of different thicknesses.

The sealing units can be fastened on the body using bonding techniques customary in the prior art, such as, for example, welding or adhesive bonding using, if necessary, an adhesive.

In the context of the invention, a precisely defined volume of liquid is delayed in the chambers for a particular period of time and transported further after this time.

In the test cassette according to the invention, usually from 1 to 1000 μA preferably from 10 to 500 μl, particularly preferably from 10 to 250 μl are transported.

The chambers can be of any shape. Square detection chambers and/or round reagent chambers are preferred.

The volumes of the chambers are usually in the range from 1 to 1000 μl preferably in the range from 10 to 500 μl.

The sample chamber is typically round with a diameter of preferably from 5 to 15 mm, preferentially from 8 to 12 mm. The reagent chamber is usually round with a diameter of preferably from 5 to 15 mm, preferentially from 5 to 10 mm. Both chambers can accommodate a fluid volume in the range from 1 to 1000 μl.

The detection chamber is usually square with dimensions of preferably from 5 to 15 mm in width and from 5 to 15 mm in length, particularly preferably 10 mm×10 mm, and typically accommodates a fluid volume in the range from 1 to 1000 μl and, according to the invention, it has to be completely filled with the fluid.

The design of the sample chamber, reagent chamber and detection chamber ought to ensure an optimal flow profile with reduced void volume and optimal contact with the immobilized detection reagents possibly present.

The channels can be straight or curved, preferably straight with angular turns. As a result, relatively long channels can be introduced into the limited area of the cassette. The channel transverse section is of any shape, usually round or square, preferably round. The transverse-sectional sizes of the channels can be the same or different; channels of the same size, usually with a transverse section or diameter in the range from 0.2 to 3 mm, preferably in the range from 0.5 to 1.5 mm, are preferred. The length of the channels is usually in the range from 5 mm to 1000 mm, preferably in the range from 5 mm to 500 mm.

In the present invention, fluids are transported using a means for transporting sample fluids, wherein the transportation is precisely defined in terms of time and volume. Preferably, predefined fluid volumes are pushed from one chamber into the next.

The means for transporting sample fluids is part of an apparatus for operating the test cassette according to the invention, which apparatus is likewise provided by the present invention. More particularly, the means for transporting sample fluids is integrated into a coupling site for introducing the test cassette into the above-mentioned apparatus.

Preferably, fluids are handled only in the test cassette according to the invention, and so the above-mentioned apparatus does not get into contact with sample fluid or reagents.

Usually, air blasts which are precisely defined in terms of time and volume are administered into the test cassette via the means for transporting sample fluids. By means of these air blasts, the sample fluid is conducted through the various channels and cavities.

The sample fluid to be analysed is introduced into the test cassette through the inlet, preferably into a sample chamber. The test cassette is subsequently sealed air-tight, usually by means of one or more covers. The covers can be made of polymeric or inorganic materials which are bound air-tight to the body by various techniques, such as, for example, adhesive bonding, welding, lamination, etc.

In one particular embodiment of the test cassette, the reagents in the reagent chamber are stored in a fibrous or porous material, for example fine particles or fabric, in the form of a reagent pad into which reagents have been taken up (adsorbed onto, fixed onto, dispersed into, dried into).

The reagent pad is selected such that it meets the requirements of the detection chamber with regard to the required fluid volume of the supernatant solution and to the concentration of the individual components in this solution.

A preferred reagent pad consists of glass or polymers, such as cellulose for example. Suitable reagent pads are those which are also used in lateral flow tests and are commercially available in various shapes. To fill this reagent chamber, the extra-thick glass filter from Pall Corporation (pore size of 1 μm, typical thickness of 1270 μm (50 mils), typical water flow rate of 210 ml/min/cm² at 30 kPa) is selected for example, with two circular filter pieces of matching diameter being stacked over one another.

The reagents of the reagent chamber are typically:
labelled or unlabelled recognition elements which are used in a recognition reaction, more particularly natural or synthetic receptors, such as, for example, complexing agents for metals/metal ions, cyclodextrins, crown ethers, antibodies, antibody fragments, anticalins, enzymes, DNA, RNA, PNA, DNA/RNA-binding proteins, membrane receptors, ion channels, cell-adhesion proteins or else gangliosides, enzymes, monosaccharides or oligosaccharides and haptamers and/or
labelled or unlabelled analytes, such as, for example, ions, proteins, natural or synthetic antigens or haptens, hormones, cytokines, monosaccharides and oligosaccharides, metabolic products or other biochemical markers which are used in diagnostics, enzyme substrates, DNA, RNA, PNA, potential active compounds, drugs, cells, viruses.

More particularly, labelled antibodies are used as recognition elements.

If required, cofactors or further chemicals which are necessary or advantageous for the reaction of a recognition element with an analyte are likewise stored in the reagent chamber.

Optionally, the reagent chamber also contains auxiliary substances for suppressing unspecific interactions between the reagents, for supporting impregnation or release of the reagents from the reagent pad, such as, for example, surface-active substances such as surfactants, lipids, biopolymers, polyethylene glycol, biomolecules, proteins, peptides.

Preferably, the reagents are applied in predefined concentrations and the reproducibility of their release during operation of the cassette is ensured.

The reagent pad is usually impregnated with from about 50 to 500 μl of a solution which contains the reagents in concentrations ranging from 10⁻³ M to 10⁻¹⁵ M, preferably nanomolar concentrations, and usually auxiliary substances in amounts of from 15% by weight to 0.1 ppb. Impregnation is achieved by, for example, drying or lyophilization.

The means for transporting sample fluids displaces the sample fluid, so that the latter flows into the reagent chamber and completely wets the reagent pad.

As a result of introduction of the analyte-containing sample fluid into the reagent chamber, the reagents are dissolved and react with the analytes or are perfectly mixed with the sample fluid.

It was found that, surprisingly, as a result of rapid—usually from 1 ms to 10 s, preferably about from 500 ms to 5 s, particularly preferably 1 s—wetting of the reagent pad with a defined sample volume (by means of the defined air blast), not only are the reagents dissolved (reconstituted) and optimally mixed with the sample fluid, but also the concentration of the reagents in the sample fluid is set with very high reproducibility. This makes it possible to perform quantitative determination of the analytes in the sample volume. After the reagent pad has been wetted, a defined period of time (preincubation time) can be allowed to elapse, for example until a biochemical reaction has ended or until a certain reaction temperature has been reached.

With a further defined air blast, the sample volume with the dissolved reagents is transported further via a channel into the detection chamber.

Preferably, the sample fluid in the test cassette is filtered ahead of the reagent chamber and is relieved of cells, blood constituents or other biological, organic or inorganic particles. For this purpose, one or more filter units, for example made of glass fibre or porous material, in the form of a (micro)cushion or channel, a glass filter paper or a membrane can be incorporated in the test cassette. The filter unit can preferably remove particles ranging from 0.2 to 100 μm from the sample fluid, preferentially particles ranging from 0.5 to 15 μm.

Preferably, ventilation of the complete channel system takes place via ventilation hole(s).

In a preferred embodiment of the invention, detection is achieved via a signal transducer (sensor platform, biochip) which is incorporated in the detection chamber as the floor. In this case, the sealing unit is applied over the complete lower side of the cassette with the exception of the detection chamber.

On the surface of the signal transducer, usually one or more separate measurement areas are defined, on which one or more further binding partners for detecting the analyte in the sample are immobilized. In the detection chamber, a biochemical reaction takes place on the surface of the biochip between the immobilized binding partner and the analyte. The labelled reaction partners are excited in the detection chamber; the signal generated is detected and used in order to quantify the analytes.

For detection, various biochips, such as, for example, surface plasmon resonance, planar waveguides, quartz microbalance, electroluminescence, can be used, and various methods, for example measurement of refractive index changes owing to binding to the surface of the biochip, can be used (see, for example, WO02/20873 and EP1316594).

Reactions in the detection chamber are, for example:
direct binding of a (detectable) analyte to the immobilized binding partner (recognition element);
direct binding of the analyte to the immobilized binding partner (recognition element) and labelling of the analyte by a second or multiple reagents from the reaction solution, which reagent can be detected optically or electrically (sandwich assay);
binding a detectable reagent to the immobilized binding partner (recognition element), which reagent competes with the analyte in the solution (competitive assay).

In a particularly preferred embodiment of the test cassette according to the invention, the biochip used is a planar thin-film waveguide which has a first optically transparent layer (a) on a second optically transparent layer (b) having a lower refractive index than layer (a), wherein one or more incoupling elements in the first optical layer (a) or in the second optical layer (b) are introduced orientated perpendicularly to the path of excitation light, wherein the excitation light in the thin-film waveguide is coupled in via the one or more incoupling elements and optionally coupled out via one or more outcoupling elements.

Preferably, the invention makes use of grating structures of the same period and/or modulation depth as incoupling elements.

Preferably, on the surface of the sensor platform, one or more reaction partners for detecting the analytes directly by means of physical absorption or electrostatic interaction are alternatively immobilized by means of a transparent optical adhesion-promoting layer. Preferably, the binding partners are selectively applied on the surface of the sensor platform in spatially separated measurement areas and the area between the measurement areas is passivated in order to suppress unspecific binding.

To apply the binding partners selectively to the surface of the sensor platform in spatially separated measurement areas, use can be made of one or more methods from the group comprising inkjet spotting, mechanical spotting by means of pin or pen, microcontact printing, fluidic contacting of the measurement areas with the biological or biochemical or synthetic recognition elements by their delivery in parallel or crossed microchannels, under the influence of pressure differences or electric or electromagnetic potentials.

Various embodiments of the sensor platform and corresponding detection methods are described in, for example, WO95/33197, WO95/33198, WO97/373211 or WO200113096. The various embodiments of the sensor platform and corresponding detection methods are hereby integrated by reference.

In a particular embodiment of the test cassette, detectable recognition elements which bind specifically to one or more analytes of the sample fluid are provided in predefined concentrations in the reagent chamber. As a result of introduction of the analyte-containing sample fluid into the reagent chamber, the recognition elements are dissolved and bind specifically to the analytes (analyte-recognition element conjugate). Here, the free binding sites of the recognition elements become increasingly saturated with increasing amounts of analyte in the sample fluid.

As a result of a further air blast, the analyte-recognition element conjugates and any recognition elements having free binding sites reach immobilized binding partners, for example analyte-protein conjugates, more particularly analyte-BSA conjugates, on the signal transducer. Recognition elements having free binding sites bind specifically to the corresponding immobilized analyte-protein conjugates.

The more detectable recognition elements having free binding sites are present in the solution, i.e. the lower the proportion of the corresponding analyte in the sample fluid, the more detectable recognition elements become bound on the chip. The analyte-saturated recognition elements from the sample fluid remain in the solution. As a result of coupling electromagnetic radiation into the biochip, the recognition elements which are labelled and are bound to the immobilized analyte-protein conjugates can be excited in the evanescent field of the waveguide. The labelled recognition elements located in the solution are not excited in this process. In this way, indirect quantification of the analytes present in the sample fluid is possible.

Combinations of detectable recognition elements and immobilized binding partners for detecting mycotoxins are described in WO2007/079893, and the content thereof is introduced in the description by reference.

In a further embodiment of the test cassette according to the invention, the floor of the detection chamber is a transparent window through which the biochemical reaction proceeding in the detection chamber can be detected. The transparent window can be formed by the sealing film, which has to be transparent in this case and consists of, for example, poly(methyl methacrylate) (PMMA), or be an independent element. In this case, the window preferably consists of glass or of a plastic which is transparent to the light used, and is fastened onto the side of the test cassette by means of the sealing unit with the exception of the detection chamber.

In this embodiment, reagents are preferably stored only in the reagent chamber, in which mixing with the sample fluid takes place before transportation into the detection chamber.

Usually, depending on the concentration of the analyte to be determined, a reagent in the solution is converted such that it changes its spectral properties—for example, absorbance, luminescence, fluorescence, etc.—which can be detected optically. Alternatively, a detection reagent in the solution, depending on the concentration of the analyte to be determined, is bound to a further reagent or to the analyte itself, so that the detection reagent changes its spectral properties—for example, absorbance, luminescence, fluorescence, electroluminescence, electrical capacitance, etc.—which can be detected optically.

In a further embodiment, there are located in the detection chamber one or more signal transducers through which the biochemical reaction proceeding in the detection chamber can be detected. In this embodiment, the window can be transparent or lightproof. Here, the reagents are likewise preferably stored only in the reagent chamber, in which mixing with the sample fluid takes place before transportation into the detection chamber.

In this case, a reagent in the solution, depending on the concentration of the analyte to be determined, can be converted such that it changes its material properties—for example, absorbance, luminescence, fluorescence, electroluminescence, capacitance, conductivity, pH, mass, etc.—which can be detected by the signal transducer. Alternatively, a detection reagent in the solution, depending on the concentration of the analyte to be determined, is bound to a further reagent or to the analyte itself, so that the detection reagent changes its material properties—such as, for example, absorbance, luminescence, fluorescence, electroluminescence, electrical capacitance, conductivity, pH, mass, etc.—which can be detected by the signal transducer.

The combination of a transparent window for detecting optical signals as the floor of the detection chamber with further signal transducers in the detection chamber is likewise possible in the context of the present invention.

In a further embodiment of the present invention, each test cassette bears a bar code which preferably includes the following information to describe the test cassette:
assay type,
batch/lot number/date of manufacture
expiry date
spot array geometry coding which describes the geometry of the measurement areas.

In a preferred embodiment of the present invention, this information is read and used by the apparatus for bioassaying analytes by means of biosensors and/or chemosensors containing the test cassette according to the invention, which is likewise provided by the present invention.

For certain applications, it may be advantageous for a test cassette to have two or more channel and chamber systems placed next to one another, so that various detection reactions might be conducted simultaneously in one test cassette.

The present invention further provides an apparatus for bioassaying analytes by means of biosensors and/or chemosensors which comprises the test cassette according to the invention, at least one coupling site for positioning the test cassette according to the invention, at least one means for transporting sample fluids in the test cassette. To ensure optimal reproducible results, the apparatus according to the invention also has at least one temperature control unit for controlling the operating temperature in the test cassette.

In a preferred embodiment of the apparatus according to the invention, the temperature control unit has at least one planar temperature-controllable element, onto which the thin side of the test cassette according to the invention is placed, so that rapid temperature equalization between the temperature-controlled support and the sample solution in the chambers can take place. For example, use can be made of Peltier or cartridge elements for temperature control of the support.

Ideally, the temperature control unit is computer-controlled and the temperature is held constant during operation of the test cassette. Preferably, the test cassette is operated at a temperature of from 20 to 37° C., preferably at around 25° C.

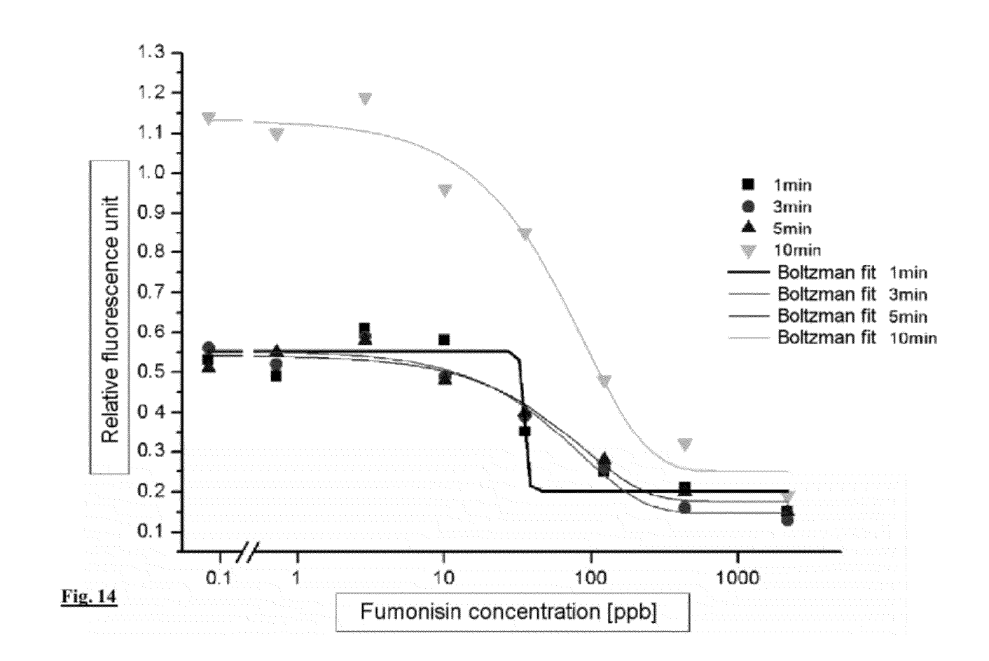

With regard to temperature control, preferably care is taken that no condensation occurs on the test cassette, which might impair optical detection. Attention ought to be paid to the temperature of the test cassette, room temperature and the particular ambient air humidity. (FIG. 13: dew point temperature diagram). Preferably, the apparatus according to the invention is operated at temperatures of from 15 to 40° C. and at a relative air humidity of 65%.

Usually, the coupling site has a mechanical trigger which starts the reaction, i.e. the first air blast, using the means for transporting sample fluid, and/or temperature control by means of the temperature control unit in the test cassette.

In a particular embodiment of the invention, the apparatus according to the invention also has at least one optical unit which comprises at least one source of excitation light, more particularly a laser, and at least one readout unit for detecting the biochemical reaction in the detection chamber of the test cassette according to the invention.

Preferably, the readout unit is a spatially resolving detector, for example from the group comprising CCD cameras, CCD chips, photodiode arrays, avalanche diode arrays, multichannel plates and multichannel photomultipliers.

Usually, the optical unit also has mirrors, prisms and/or lenses for shaping—more particularly, focussing, splitting, redirecting and orientating—the excitation light.

To operate a test cassette having a PWG sensor platform, it is advantageous to integrate a goniometer for monitoring and regulating the excitation path, more particularly for optimizing the coupling parameters by positioning the laser beam with regard to angle of incidence and position to the grating structure, into the optical unit. Precise setting of the laser beam maximizes the intensity of the light scattered from the PWG sensor platform.

Preferably, the test cassette is likewise precisely held in the coupling site by means of a fastening unit.

If a test cassette having a PWG sensor platform is used, a precision of 100 μm parallel to the grating and of 200 μm normal to the surface of the PWG chip is preferred. The second positioning is set in the course of incoupling adjustment with a resolution of 50 μm. It should be mentioned that the quality of the signals depends on the exact positioning of the sensor platform to the laser beam, and so tolerance limits should be observed.

Usually, the test cassette is sealed with, for example, a silicone cover, and the means for transporting the sample fluid, for example a pressure surge, a syringe, a plunger or a pump, preferably a pump, pushes a first volume of air into the test cassette. The air pressure transports the sample fluid from the sample chamber into the reagent chamber and wets the reagent pad. This starts the preincubation phase, during which, for example, the toxins of the sample react with the fluorescent antibody. Usually, the preincubation time is in the range from 1 to 20 min, preferably in the range from 3 to 7 min, depending on the reaction partners. Usually, a prolonged preincubation time produces a stronger signal. Preferably, the preincubation time is controlled with a precision of 3 seconds. In a further step, the means for transporting the sample fluid pushes a second predefined volume of air into the test cassette, leading to further transportation of the sample fluid—optionally through a filter—into the channel and into the detection chamber. The main incubation takes place therein, which usually lasts from 1 to 100 min.

Detection is preferably carried out after 1 to 30 minutes, preferably after 5 to 15 minutes with a precision of ±5 seconds. For this purpose, a laser beam is, for example, guided into the detection chamber onto the surface of the sensor platform and the fluorescence generated is registered by the readout unit. Usually, the reaction has not yet reached equilibrium. It is therefore preferred that the duration of the respective steps is precisely adhered to in order to ensure the reproducibility of the measurement.

Preferably, the apparatus according to the invention has a control unit for automatically controlling the means for transporting sample fluid and/or the temperature control unit and/or the optical unit and corresponding positioning of the test cassette in the coupling site by means of a fastening unit, control and setting of the biochemical reaction parameters, such as, for example, incubation time/temperature, reaction time/temperature, etc. The control unit also has a computational element for calculating the analyte values by reference to a calibration curve and displaying the analyte values.

Usually, the apparatus according to the invention is operated as follows:
1. The user inserts the test cassette into the coupling site.
2. The user pushes the release button to start the apparatus according to the invention.

The apparatus according to the invention carries out on its own, by means of the control unit, the following steps:
3. The temperature control unit heats the test cassette until a temperature of, for example, 25° C. is reached and maintained.
4. If a cassette having an integrated planar waveguide is used, the coupling conditions are optimized. The position of the laser is set using the goniometer.
5. The means for transporting sample fluid transports the sample fluid into the reagent chamber. The preincubation is started.
6. The means for transporting sample fluid transports the sample fluid into the detection chamber. The main incubation is started.
7. The coupling conditions are fine-tuned. An angle compensation of 1° due to the change in refractive index (air in step 5, aqueous solution now) is taken into account.
8. The laser beam is switched on and the resulting signal is registered by the readout unit.

The present invention further provides a method for operating the test cassette according to the invention, characterized by the following steps:
A. introduction of an analyte-containing sample fluid into the test cassette,
B. transportation of the sample fluid into a reagent chamber by a means for transporting sample fluid, then
C. wetting of a reagent pad in the reagent chamber and dissolution of reagents applied there, wherein the reagent pad becomes completely wetted, the rate of wetting is controlled and is preferably in the range from 1 ms to 10 s,
D. optional preincubation, wherein the preincubation time is preferably controlled with a precision of 3 seconds, then
E. transportation into a detection chamber by a means for transporting sample fluid, wherein the detection chamber becomes completely filled,
F. biochemical reaction, optionally with reagents applied in the detection chamber (incubation), which is used for quantitative determination of one or more analytes, wherein the incubation time is controlled, followed by
G. excitation and measurement of changes in the spectral properties and/or material properties of the sample fluid in the detection chamber
H. calculation and displaying of the analyte values by reference to a calibration curve.

For the reproducibility of the method, preferably a precisely defined volume of sample fluid is transported. It is also advantageous to control the temperature of the cassette in the reagent chamber and in the detection chamber using the temperature control unit during operation.

For the reproducibility of the result when repeating the method with another test cassette, it is preferred for the parameters, more particularly volumes, times (transportation and incubation times) and/or temperature, to be defined and to be automatically controlled by the control unit.

A major advantage of the invention is that the person carrying out an analysis with the novel microfluidic test cassette does not have to carry out any quantitative process steps for the analysis, such as, for example, exact dispensing of the sample volume and exact dispensing of the reagents. As a result, the biochemical test method can also be carried out by persons who are not analysis experts. A further advantage is that, before the start of the test, no fluids are stored in the test cassette, but instead only dry reagents. A major advantage of the system is that, apart from the sample solution, no further fluids have to be added, making the method simple to carry out. At the end of the analysis, the sample fluid remains in the test cassette, and so no danger to the environment owing to poisonous or infectious substances can materialize. This use of the test cassette as a disposable cassette is made economically viable by a simple design and, accordingly, low production costs.

The use of the test cassette according to the invention, apparatus for operating the test cassette and method for operating the test cassette in environmental analysis, the food sector, human and veterinary diagnostics and crop protection in order to determine analytes qualitatively and/or quantitatively is likewise provided by the present invention.

Examples of said use are quantitative and/or qualitative determination of chemical, biochemical or biological analytes in screening methods in pharmaceutical research, combinatorial chemistry, clinical and preclinical development, for real-time binding studies and for determining kinetic parameters in affinity screening and in research, for qualitative and quantitative analyte determinations, more particularly for DNA and RNA analysis and determining genomic or proteomic differences in the genome, such as single nucleotide polymorphisms for example, for measuring protein-DNA interactions, for determining control mechanisms for mRNA expression and for protein (bio)synthesis, for generating toxicity studies and for determining expression profiles, more particularly for determining biological and chemical marker substances, such as mRNA, proteins, peptides or low molecular weight organic (messenger) substances, and for detecting antibodies, antigens, pathogens or bacteria in pharmaceutical product research and development, human and veterinary diagnostics, agrochemical product research and development, symptomatic and presymptomatic plant diagnostics, for patient stratification in pharmaceutical product development and for therapeutic selection of drugs, for detecting pathogens, harmful substances and germs, more particularly salmonellae, prions, viruses and bacteria, particularly in foodstuff and environmental analyses.

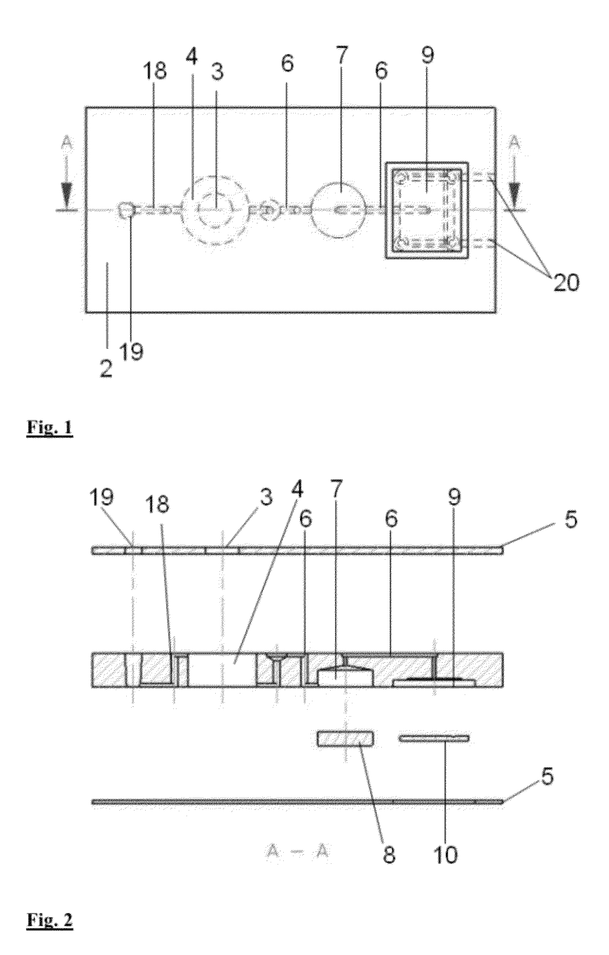

Particular embodiments of the test cassette according to the invention are shown in FIGS. 1 to 6, without being limited thereto.

FIG. 1: Test cassette

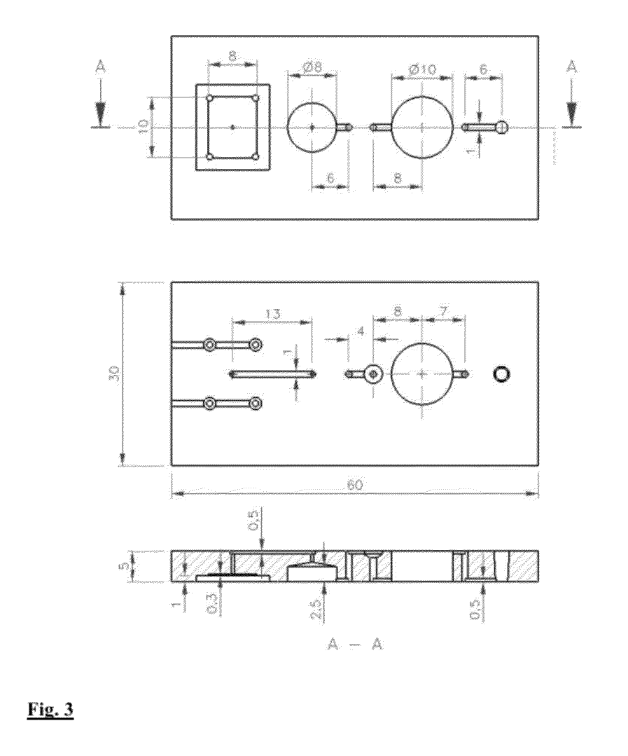

FIG. 2: Test cassette, side view

FIG. 3: Test cassette with dimensioning

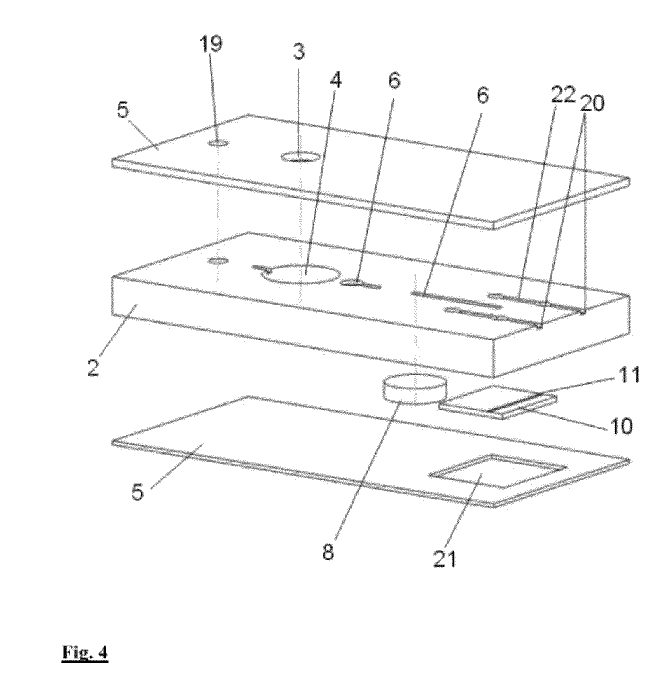

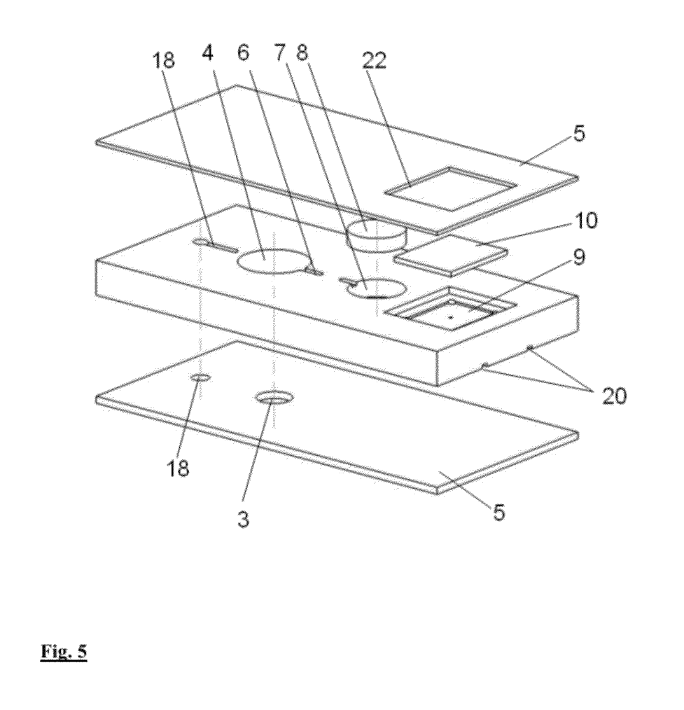

FIG. 4: Design of the test cassette—lateral view from above

FIG. 5: Design of the test cassette—lateral view from below

FIG. 6: PWG biochip

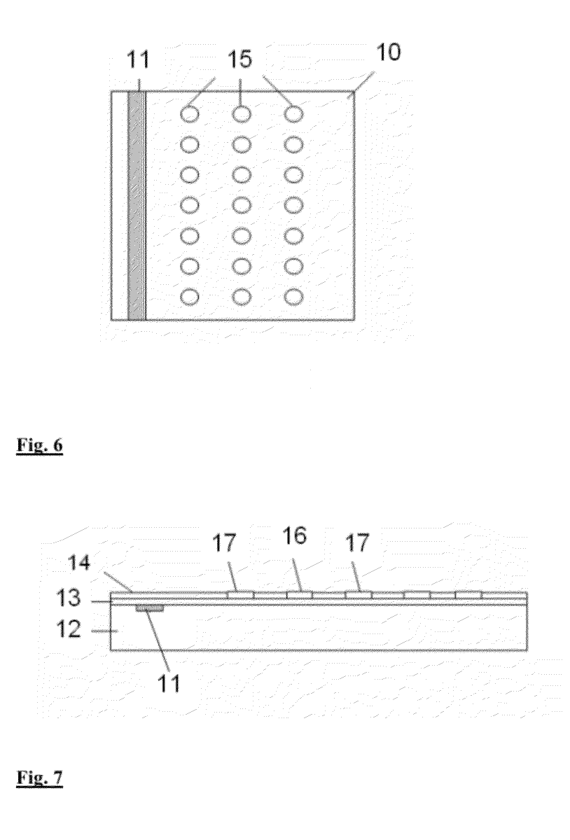

FIG. 7: PWG biochip, side view

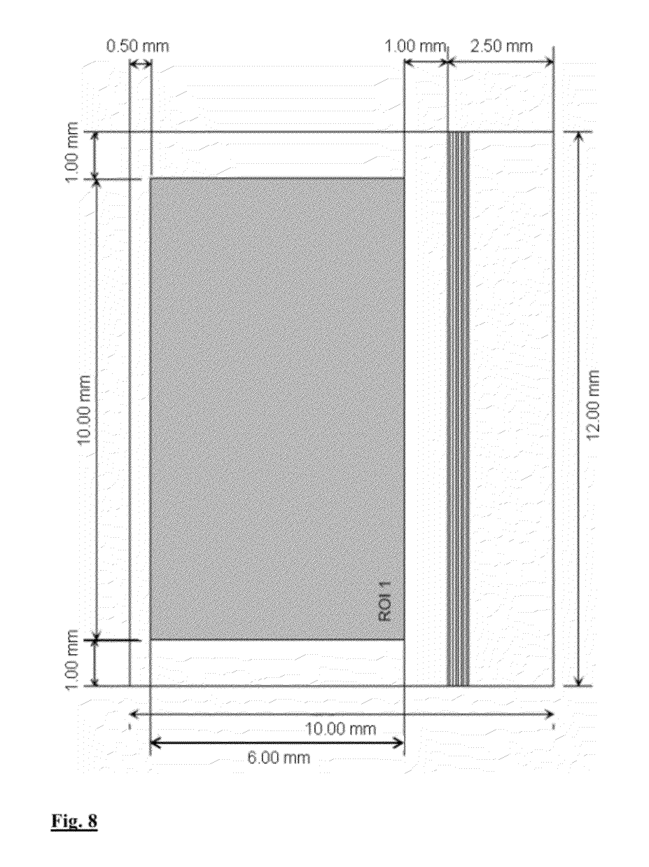

FIG. 8: Dimensions of the PWG biochip

### REFERENCE SYMBOLS

1 Test cassette
2 Structured body
3 Inlet
4 Sample chamber
5 Sealing film
6 Channel
7 Reagent chamber
8 Reagent pad
9 Detection chamber
10 PWG biochip
11 Grating
12 Thin wave-guiding layer on a glass plate (not drawn)
13 Adhesion-promoting layer
14 BSA
15 Arrays
16 Mycotoxin-BSA conjugate spots
17 Reference spots
18 Air channel
19 Air hole
20 Ventilation hole
21 Window of the sealing film
22 Ventilation channel

The test cassette 1 consists of a structured body 2, into which channels and cavities are introduced. This body is provided with a sealing film 5 on the upper and lower sides, resulting in the various cavities and channels of the structured body being sealed air-tight (with the exception of the openings 3, 19 and 20).

For example, the test cassette according to the invention was produced using an injection moulding method. The body consists of a plate made of black polyoxymethylene (POM), in which the channels and chambers have been drilled out and milled off.

The test cassette 1 comprises an inlet 3 for the intake of a sample fluid containing the analyte to be detected into the test cassette 1, a reagent chamber 7, into which the sample fluid is transported via a channel 6, and a detection chamber 9, into which the analyte is transported via a further channel 6 and which comprises a PWG biochip 10.

The sample chamber 4 is round with a diameter of 10 mm. The reagent chamber 7 is round with a diameter of 8 mm. The detection chamber 9 is square with dimensions of 10 mm×10 mm. The channels 6 have a round transverse section with a diameter of 1 mm.

In the reagent chamber 7, fluorescent dye-labelled antibodies specific for an analyte from the sample fluid are situated, impregnated on a reagent pad 8.

The reagent pad 8 consists of extra-thick glass filters from Pall Corporation (pore size of 1 μm, typical thickness of 1270 μm (50 mils), typical water flow rate of 210 ml/min/cm² at 30 kPa), with two circular filter pieces of 8 mm in diameter being stacked over one another.

Both the PWG biochip 10 and the reagent pad 8 are held between two polyolefin films in the POM plate 2, which also serve as sealing films 5 for sealing the test cassette. The film has, in the region of the PWG biochip 10, a window 21 which allows free access to the measurement region of the PWG biochip 10. The upper sealing film 5 is 180 μm thick, and the lower sealing film 5 is 80 μm thick.

The sample fluid is introduced into the sample chamber 4 at the start of the test and sealed air-tight with a suitable silicone cover. The fluid is distributed in the sample chamber 4 and in the adjoining channels 6, which are designed such that the fluid is not drawn by capillary forces into the reagent chamber 7 or to the inlet 3. By means of the transportation unit, a defined air volume is introduced at the inlet into the sample chamber 4 via the channel 6. This air volume displaces the sample fluid, so that it flows into the reagent chamber 7 and completely wets the reagent pad 8.

As a result of introducing the sample fluid into the reagent chamber 7, the antibodies are dissolved and bind specifically to the analytes present in the sample fluid (analyte-antibody conjugate). The free binding sites of the antibodies become increasingly saturated with increasing amounts of analytes in the sample fluid.

After a certain retention time (10 minutes) at a temperature of 25° C., the sample fluid containing analyte-antibody conjugates is transported by a further defined air blast in a next step into the detection chamber 9. The detection chamber 9 is completely filled with the sample fluid.

Ventilation of the complete channel system occurs via the ventilation hole(s) 20, which are applied in the upper sealing film.

The detection chamber 9 comprises a PWG biochip 10. A diagram of the PWG biochip 10 is shown in FIG. 6 (top view) and in FIG. 7 (side view).

In the detection chamber 9, the course or the end point of the biochemical detection reaction is detected.

The PWG biochip 10 in the detection chamber 9 consists of, for example, a 10 mm×12 mm glass plate having a thickness of 0.7 mm (12.0+/−0.05 mm×10.0+/−0.05 mm×0.70+/−0.05 mm) On one side of the chip, there is a 155 nm thin wave-guiding layer 12 made of Ta₂O₅ (tantalum pentoxide). The measurement region of the chip comprises a central 10 mm×6 mm rectangular detection area. Parallel to this detection area is a 500 m wide crescent-shaped band: the grating 11 for coupling in the excitation light. The positional accuracy of the grating 11 to the edges of the PWG biochip 10 is +/−0.05 mm. The grating depth is 18 nm and the grating period is 318 nm with a duty cycle of 0.5.

On the thin wave-guiding layer 12, a monolayer made of dodecyl phosphate is applied as an adhesion-promoting layer 13. On the adhesion-promoting layer 13, analyte-BSA conjugates are applied/immobilized adsorptively in the form of an array 15. The free areas between the analyte-BSA conjugate spots 16 and reference spots 17 are blocked with BSA 14 (passivation).

In the detection chamber 9, the analyte-antibody conjugates and any antibodies having free binding sites reach the immobilized analyte-BSA conjugate spots 16 on the PWG biochip 10.

Antibodies having free binding sites bind specifically to the corresponding immobilized analyte-BSA conjugates. The more antibodies having free binding sites are present in the solution, i.e. the lower the proportion of the corresponding analyte in the sample fluid, the more fluorescent dye-labelled antibodies become bound on the PWG biochip 10. The antibodies saturated with analytes in the sample fluid remain in the solution.

As a result of coupling electromagnetic radiation into the thin-film waveguide 12, the antibodies which are labelled with a fluorescent dye and bound to the immobilized analyte-BSA conjugates can be excited to fluoresce in the evanescent field of the thin-film waveguide 12. The antibodies which are labelled with a fluorescent dye and located in the solution are not excited in this connection. In this way, indirect quantification of the analytes present in the sample fluid is possible.

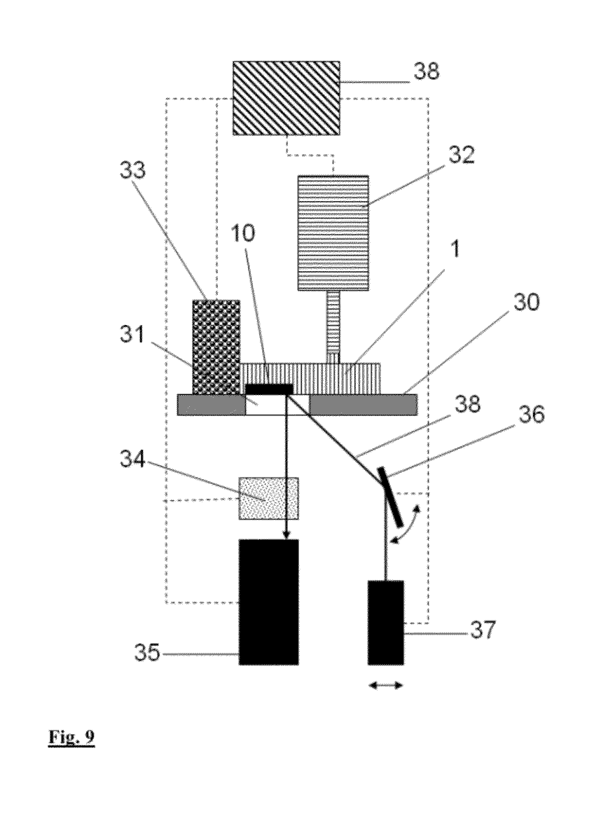

Particular embodiments of the apparatus according to the invention for operating the test cassette are shown in FIG. 9, without being limited thereto.

FIG. 9: Diagram of the apparatus according to the invention for operating the test cassette.

### REFERENCE SYMBOLS

30: Support
31: Optical window
32: Means for transporting sample fluid
33: Temperature control element—Peltier or cartridge elements
34: Lens with filters
35: CCD camera
36: Moveable mirror
37: Moveable laser
38: Control unit

The apparatus for operating the test cassette according to the invention comprises a coupling site having a support 30 for positioning the test cassette 1 according to the invention. Below the PWG biochip 10 is a window 31 in the support 30. The apparatus also comprises the means for transporting sample fluid 32 in the test cassette 1 and the temperature control element 33. In FIG. 9, the temperature control element 33 controls the temperature of the support 30 by contact, which support in turn conducts the set temperature to the test cassette 1.

The apparatus according to the invention also comprises, within the optical unit, a moveable laser 37, and at least one CCD camera 35 for detecting the biochemical reaction in the detection chamber of the test cassette 1. The optical unit also comprises a moveable mirror 36 and a lens with filters 34. Further prisms and/or lenses for shaping—more particularly, focussing, splitting, redirecting and orientating—the excitation light, and also a goniometer for monitoring and regulating the excitation path, more particularly for optimizing the coupling parameters by positioning the laser beam with regard to angle of incidence and position to the grating structure of the PWG biochip 10, are also possible (not shown in FIG. 9). Precise setting of the laser beam maximizes the intensity of the light scattered from the PWG biochip 10.

The laser beam (see FIG. 9) is reflected onto the PWG chip 10 of the test cassette 1.

Fluorescence photons obtained as a result of the light excitation are sensed by the CCD camera 35 through the optical window 31.

The coupling site also comprises a mechanical trigger which starts the reaction in the test cassette.

To ensure optimal, reproducible results, the temperature control unit 33 regulates the operating temperature in the test cassette 1. It is typically switched on by activation of the trigger to start the cassette.

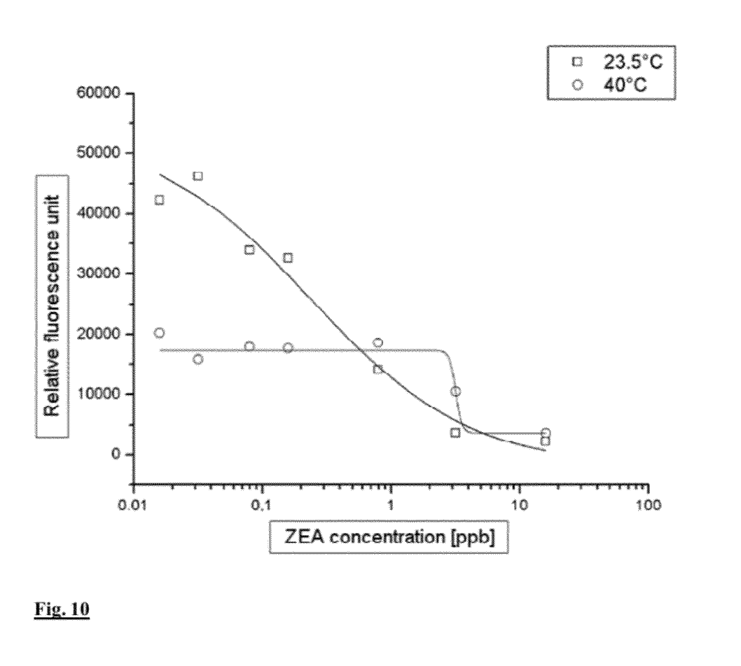

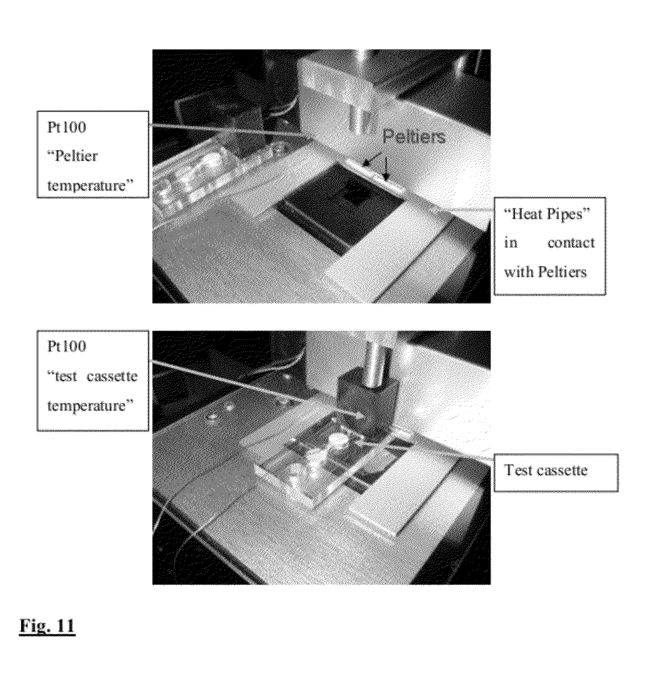

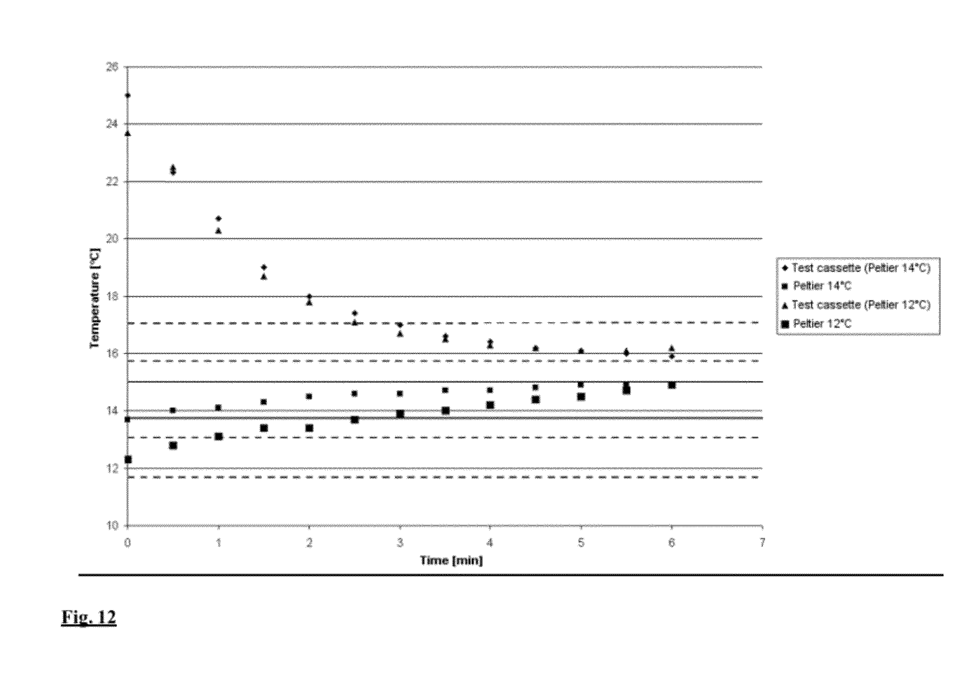

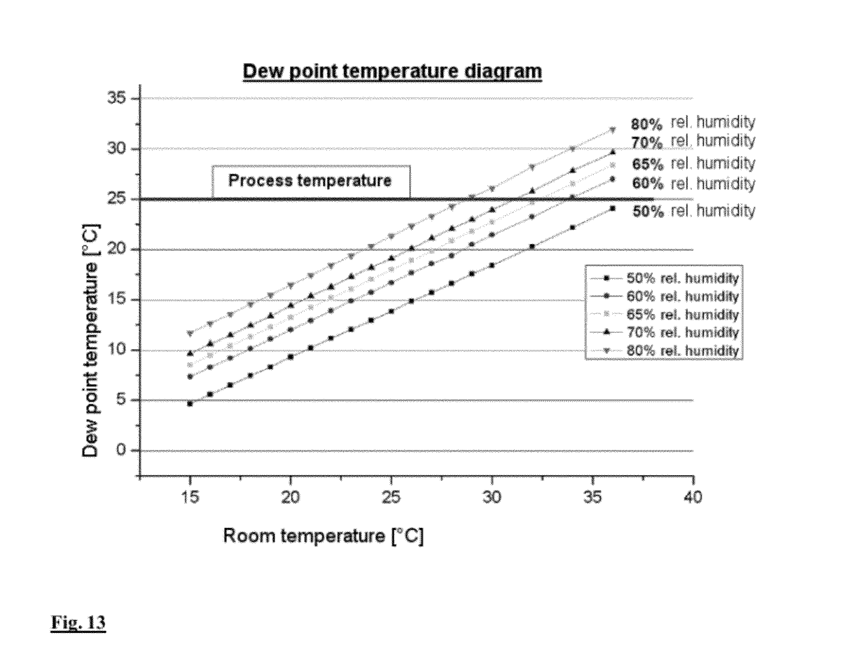

Preferably, the test cassette is operated at a temperature of around 25° C.+/−2 K. FIG. 10 shows the effect of temperature on the dose-response curve of an assay. FIG. 11 shows the experimental setup for measuring temperature control by means of Peltier elements, and FIG. 12 shows a simulation of the cooling rate of the test cassette.

The means for transporting sample fluid 32 introduces air blasts which are precisely defined in terms of time and volume into the sealed test cassette. By means of these air blasts, the sample fluid is conducted through the various channels 6 and cavities, with various reaction steps being carried out there, for example reconstitution of the reagents, mixing of the reagents with the sample, etc.

The test cassette 1 is sealed with a silicone cover 21, and the means for transporting sample fluid 32 (a pump) pushes a first volume of air into the test cassette 1. The air pressure transports the sample fluid from the sample chamber 4 into the reagent chamber 7 and wets the reagent pad 8. This starts the preincubation phase, during which, for example, the toxin of the sample reacts with the fluorescent antibody. Usually, the preincubation time is in the range from 2 to 5 min±3 seconds, depending on the reaction partners. Usually, a prolonged preincubation time produces a stronger signal. FIG. 14 shows the effect of incubation time on the dose-response curve of the assay based on the mycotoxin fumonisin. In a further step, the means for transporting sample fluid 32 pushes a second predefined volume of air into the test cassette 1, leading to further transportation of the sample fluid—optionally through a filter—into the channel 6 and into the detection chamber 9 where the main incubation takes place. Detection is preferably carried out after ten minutes with a precision of ±5 seconds. For this purpose, a laser beam is guided into the detection chamber 9 onto the surface of the PWG biochip 10 and the fluorescence generated is recorded by the CCD camera 35. Usually, the reaction has not yet reached equilibrium. The duration of the respective steps is precisely adhered to.

The analyte values are calculated by reference to a calibration curve by means of a computational element of the control unit 38 and displayed.

For the reproducibility of the result when repeating the method with another test cassette, the parameters, more particularly volumes, times (transportation and incubation times) and/or temperature, are defined and the respective elements of the apparatus are automatically controlled by the control unit 38.

1. Test cassette for qualitative and/or quantitative analysis of analytes, comprising a structured body in which there are introduced cavities which are connected to one another by channels, wherein the test cassette comprises:
at least one inlet for introducing a sample fluid containing the analyte,
at least one reagent chamber in which one or more reagents for reaction with the analyte or for mixing with the sample fluid are stored, and
at least one detection chamber in which a signal for detection or quantitative analysis of the analyte is detected,
wherein:
the floor or the ceiling of the detection chamber consists of a signal transducer or a window for detection of a signal,
the channels are designed such that the fluids cannot be drawn by capillary forces into the reagent chamber or to the opening,
the reagents in the reagent chamber and, optionally, further reagents in the detection chamber are stored in dry form.

2. Test cassette according to claim 1, wherein the reagents in the reagent chamber are applied to a reagent pad.

3. Test cassette according to claim 1, wherein at least one side of the body is sealed by means of a sealing unit.

4. Test cassette according to claim 3, wherein the sealing unit is a sealing film.

5. Test cassette according to claim 4, wherein the sealing unit has a thickness of from 30 μm to 1000 μm.

6. Test cassette according to claim 1, wherein the reagent chamber and the detection chamber are accommodated on the lower side of the body.

7. Test cassette according to claim 1, wherein the signal transducer or the window for detection of a signal forms the floor of the detection chamber.

8. Test cassette according to claim 1, wherein the floor of the detection chamber is a signal transducer and, on the signal transducer, one or more separate measurement areas are defined, on which one or more further binding partners for detecting the analyte in the sample are immobilized.

9. Test cassette according to claim 8, wherein the signal transducer is a planar waveguide.

10. Apparatus for bioassaying analytes by means of biosensors and/or chemosensors, comprising the test cassette according to claim 1, at least one coupling site for positioning the test cassette, at least one means for transporting sample fluids in the test cassette and at least one temperature control unit.

11. Apparatus according to claim 10, wherein the temperature control unit has at least one planar temperature-controllable element which is contacted with the lower side of the test cassette.

12. Apparatus according to claim 11, wherein the temperature of the planar temperature-controllable element is controlled by means of a Peltier or a cartridge element.

13. Apparatus according to claim 10, wherein the apparatus has an optical unit comprising at least one source for exciting the sample fluid in the detection chamber, at least one readout unit for detecting a signal in the detection chamber, and, optionally, mirrors, prisms and/or lenses.

14. Apparatus according to claim 10, wherein the apparatus has a control unit for automatically controlling the means for transporting sample fluids and/or the temperature control unit and/or the optical unit.

15. Method for operating the apparatus according to claim 10, comprising the following steps:
A. introducing an analyte-containing sample into the test cassette,
B. transporting the sample fluid into the reagent chamber by the means for transporting sample fluid,
C. wetting of a reagent pad in the reagent chamber and dissolution of reagents applied there, wherein the reagent pad becomes completely wetted and the rate of wetting is controlled,
D. optionally preincubating, wherein the preincubation time is controlled, then
E. transporting into the detection chamber by the means for transporting sample fluid, wherein the detection chamber becomes completely filled,
F. biochemically reacting, optionally with reagents applied in the detection chamber (incubation), which is used for quantitative determination of one or more analytes, wherein the incubation time is controlled, followed by
G. excitation and measuring of changes in the spectral properties and/or material properties of the sample fluid in the detection chamber, and
H. calculation and displaying of the analyte values by reference to a calibration curve.

16. Method according to claim 15, wherein the rate of wetting is in the range from 1 ms to 10 s.

17. Method according to claim 15, wherein a precisely defined volume of sample fluid is transported.

18. Method according to claim 15, wherein the temperature in the reagent chamber and in the detection chamber is controlled during operation.

19. Method of determining analytes qualitatively and/or quantitatively comprising determining the analytes qualitatively and/or quantitatively using the test cassette according to claim 1.
